(19) United States
(12) Patent Application Publication
(10) Pub. No.: US 2025/0331450 A1
(43) Pub. Date: Oct. 30, 2025

(54) ADJUSTABLE LINK FOR A FLEX WING CUTTER

(71) Applicant: Oregon Tool, Inc., Portland, OR (US)

(72) Inventor: Jason Carlson, Bryon, IL (US)

(73) Assignee: Oregon Tool, Inc., Portland, OR (US)

(21) Appl. No.: 18/646,286

(22) Filed: Apr. 25, 2024

(51) Int. Cl. A01D 34/24

(52) U.S. Cl. CPC A01D 34/243

(57) ABSTRACT

An adjustable link for a flex wing cutter includes a first end portion, a second end portion, and a shaft. The first end portion provides first rotation about a first pin of the first end portion and second rotation about a second pin of the first end portion. The second end portion provides third rotation about a third pin of the second end portion and fourth rotation about a fourth pin of the second end portion. The shaft extends between the first end portion and the second end portion and is selectively repositionable relative to the first end portion to adjust a distance between the first end portion and the second end portion. The second end portion is configured to rotate about the shaft to provide a fifth rotation without adjusting the distance between the first end portion and the second end portion.

### BACKGROUND

The present disclosure relates generally to flex wing cutters. Flex wing cutters can be used in the lawn mowing profession and/or by amateur users to cut or trim plants.

### SUMMARY

In one embodiment, an adjustable link for a flex wing cutter comprises a first end portion, a second end portion, and a shaft. The first end portion provides first rotation about a first pin of the first end portion and second rotation about a second pin of the first end portion. The second end portion provides third rotation about a third pin of the second end portion and fourth rotation about a fourth pin of the second end portion. The shaft extends between the first end portion and the second end portion and is selectively repositionable relative to the first end portion to adjust a distance between the first end portion and the second end portion. The second end portion is configured to rotate about the shaft to provide a fifth rotation without adjusting the distance between the first end portion and the second end portion.

In another embodiment, a cutter comprises an adjustable link and a wing. The adjustable link comprises a first end portion, a second end portion, and a shaft. The first end portion provides first rotation about a first pin of the first end portion and second rotation about a second pin of the first end portion. The second end portion provides third rotation about a third pin of the second end portion and fourth rotation about a fourth pin of the second end portion. The shaft extends between the first end portion and the second end portion and is selectively repositionable relative to the first end portion to adjust a distance between the first end portion and the second end portion. The wing utilizes a fifth rotation, and the second end portion is configured to rotate about the shaft to provide the fifth rotation without adjusting the distance between the first end portion and the second end portion.

In yet another embodiment, a cutter comprises a chassis, a first connection piece, an adjustable link, a second connection piece, and a wing. The first connection piece is coupled to the chassis. The adjustable link comprises a first end portion, a second end portion, and a shaft. The first end portion provides first rotation about a first pin of the first end portion and second rotation about a second pin of the first end portion. The first end portion is coupled to the first connection piece. The second end portion provides third rotation about a third pin of the second end portion and fourth rotation about a fourth pin of the second end portion. The shaft extends between the first end portion and the second end portion. The shaft is selectively repositionable relative to the first end portion to adjust a distance between the first end portion and the second end portion. The second connection piece is coupled to the second end portion. The wing is coupled to the second connection piece. The second end portion is configured to rotate about the shaft to provide a fifth rotation without adjusting the distance between the first end portion and the second end portion.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a perspective view of an example cutter including an adjustable link, according to some embodiments.

FIG. 2 is a perspective view of a portion of the cutter shown in FIG. 1, according to some embodiments.

FIG. 3 is a perspective view of a portion of the cutter shown in FIG. 1, according to some embodiments.

FIG. 4 is a perspective view of the adjustable link of FIG. 1, according to some embodiments.

FIG. 5 is a front view of the adjustable link of FIG. 1, according to some embodiments.

FIG. 6 is a back view of the adjustable link of FIG. 1, according to some embodiments.

FIG. 7 is a right view of the adjustable link of FIG. 1, according to some embodiments.

FIG. 8 is a left view of the adjustable link of FIG. 1, according to some embodiments.

FIG. 9 is a top view of the adjustable link of FIG. 1, according to some embodiments.

FIG. 10 is a bottom view of the adjustable link of FIG. 1, according to some embodiments.

FIG. 11 is a cross sectional view of Section A-A of the adjustable link of FIG. 1, according to some embodiments.

It will be recognized that the Figures are the schematic representations for purposes of illustration. The Figures are provided for the purpose of illustrating one or more implementations with the explicit understanding that the Figures will not be used to limit the scope of the meaning of the claims.

### DETAILED DESCRIPTION

Following below are detailed descriptions of various concepts related to, and implementations of, methods, apparatuses, and for providing an adjustable link for a flex wing cutter. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

An aspect of the present disclosure is a determination that it would be desirable to provide customers (e.g., grounds personal, homeowners, etc.) with a linkage to a flex wing cutter that is capable of preventing the flex wing from becoming out of level. In the context of mowing lawns, the present disclosure includes a determination that flex wing cutters become out of level due to their turnbuckles. The deleveling of the flex wings can be burdensome to consumers since the customer must stop and relevel the flex wings or replace the turnbuckle before returning to their cutting task. Therefore, the constant deleveling creates both a time and capital inefficiency for customers. Conventional flex wing cutters become out of level due to their turnbuckle's inability to consistently transmit large loads in both tension and compression without failure. When the force to twist the turnbuckle is too high, the force is exerted on the threads, thus loosening a locknut of the conventional flex wing cutter. As a wing of the conventional flex wing cutter flexes, the threaded end continues to turn and change the turnbuckle's length. The turnbuckle length change results in the flex wings becoming out of level.

Implementations described herein are related to a cutter including a wing and an adjustable link. The cutter uses the adjustable link to adjust the wing to a desired position relative to a center of the flex wing cutter (e.g., a center of a deck coupled to the wing, etc.) and keeps the wing locked in the desired position. The adjustable link separates pivoting elements, which allows the use of bearings and individually greaseable pivots. The adjustable link includes grease points at external access points configured to receive grease. Channels extend from the external access points to grease abutting surfaces within the adjustable link. In this way, the adjustable link within the cutter is more desirable than other flex wing systems which are not capable of retaining a desired wing position over long periods of time. These and other features and advantages of the present application will be described in further detail below with reference to the Figures.

### II. Overview of Adjustable Link

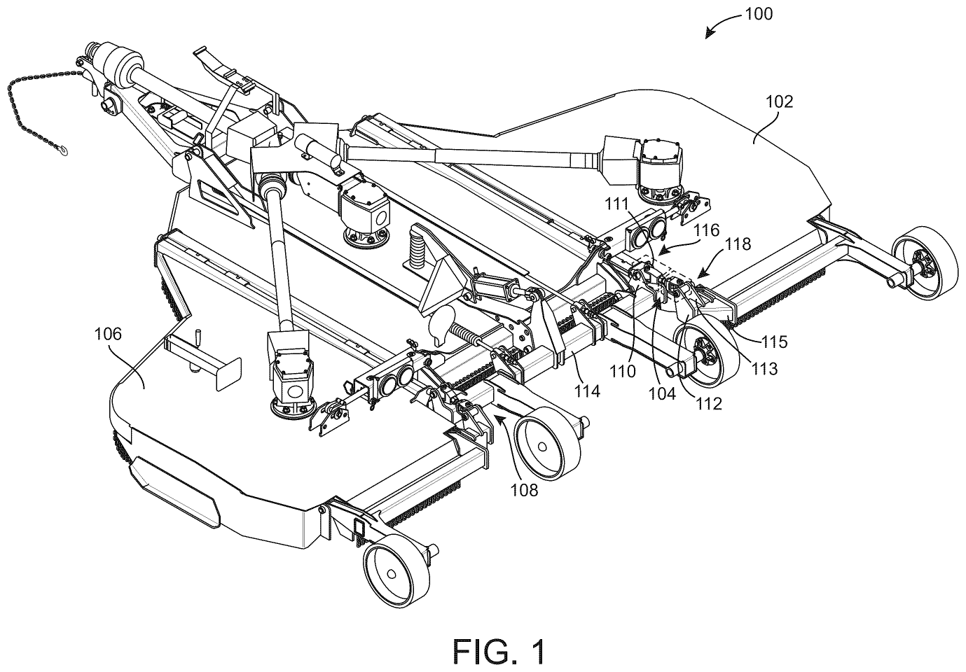

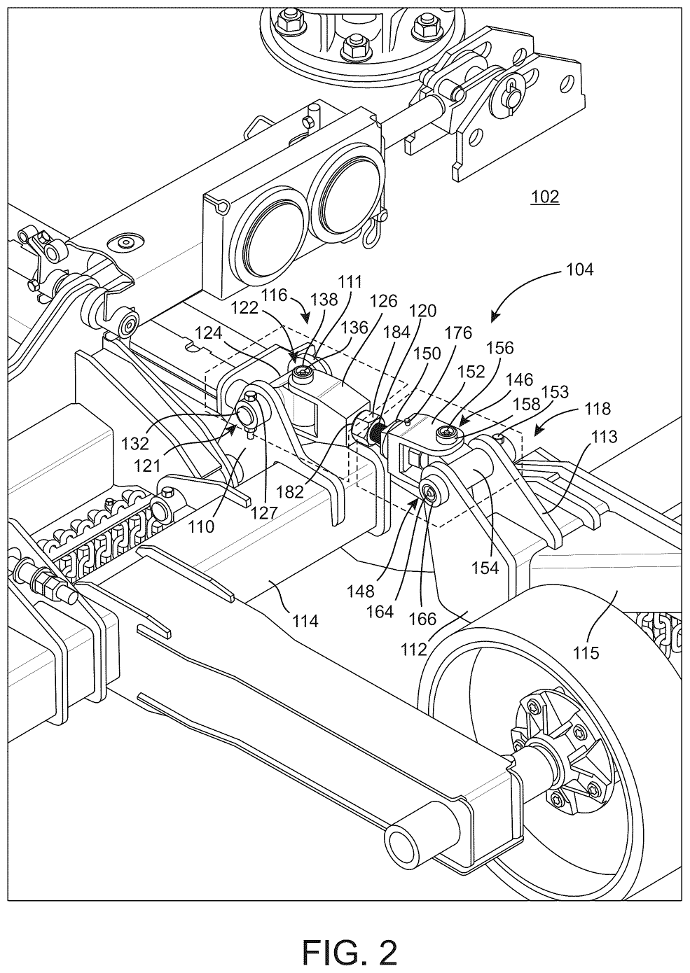

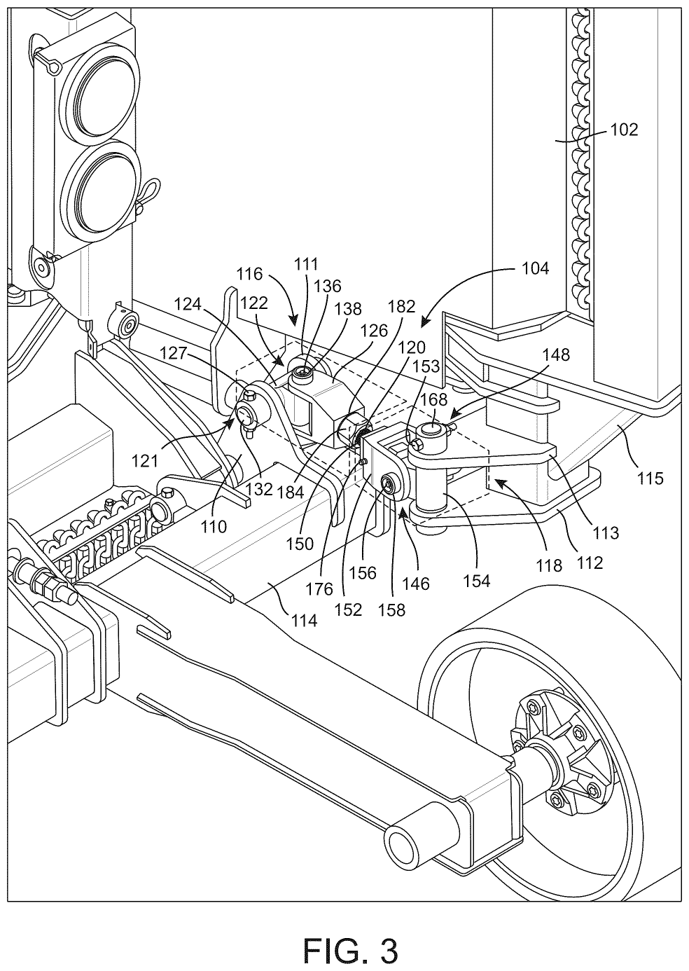

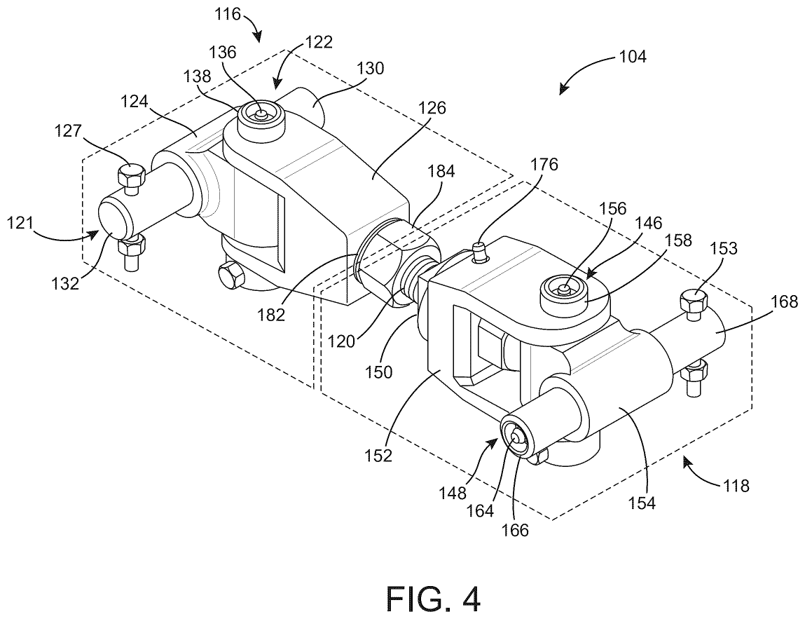

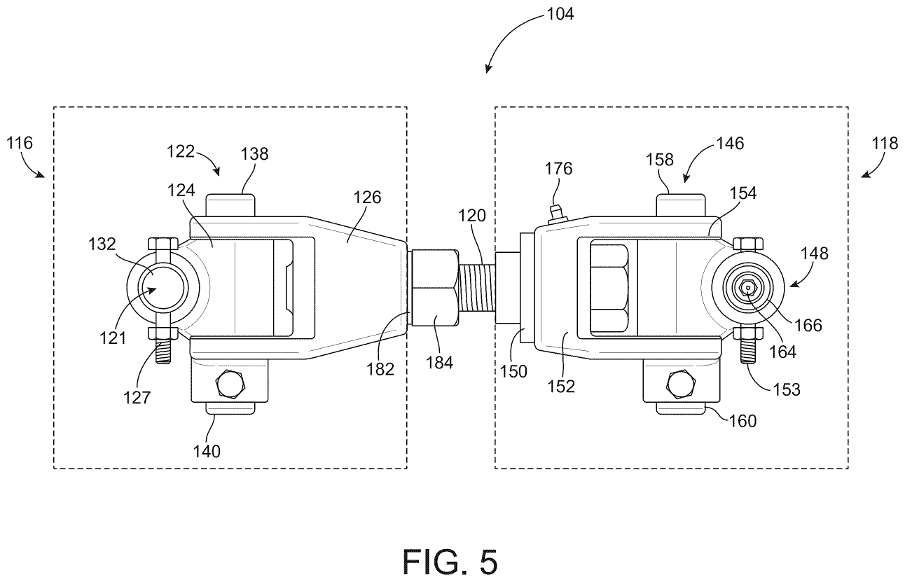

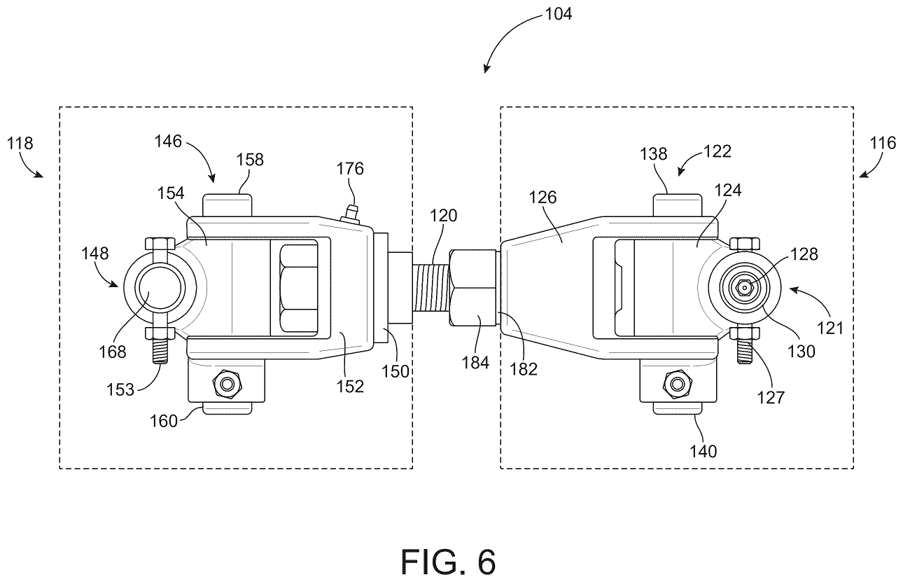

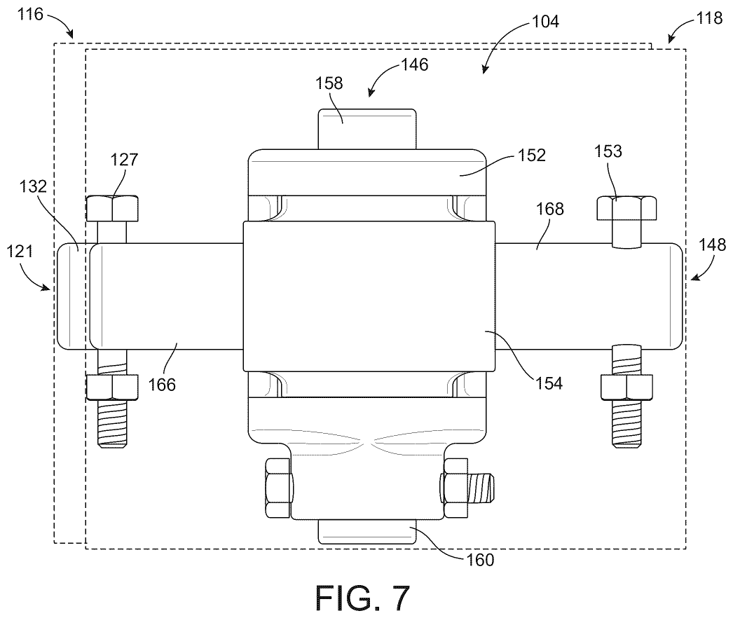

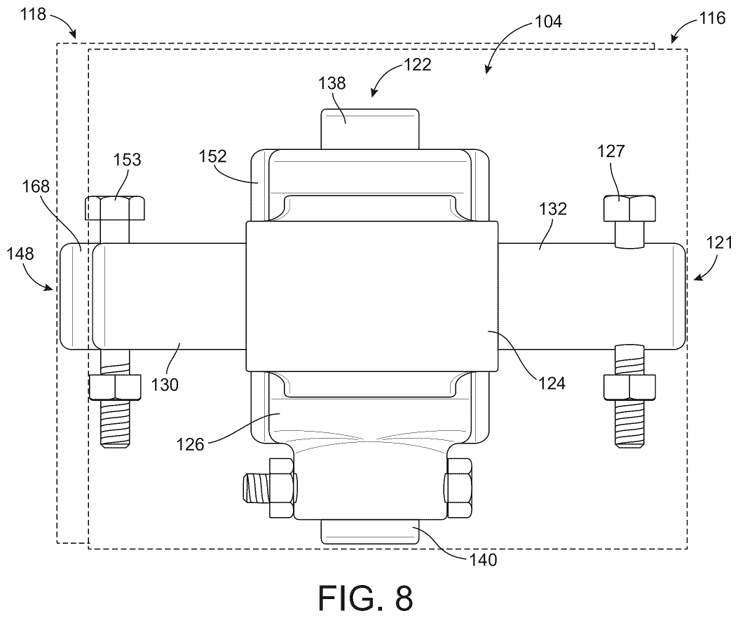

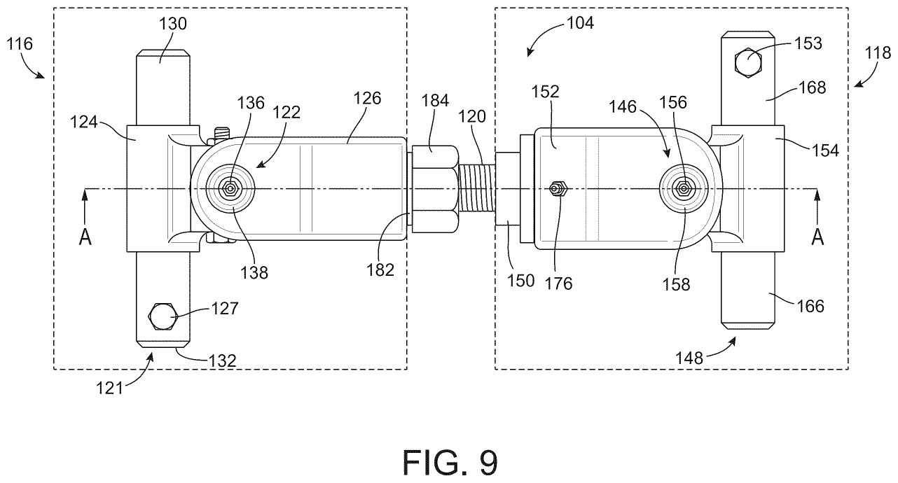

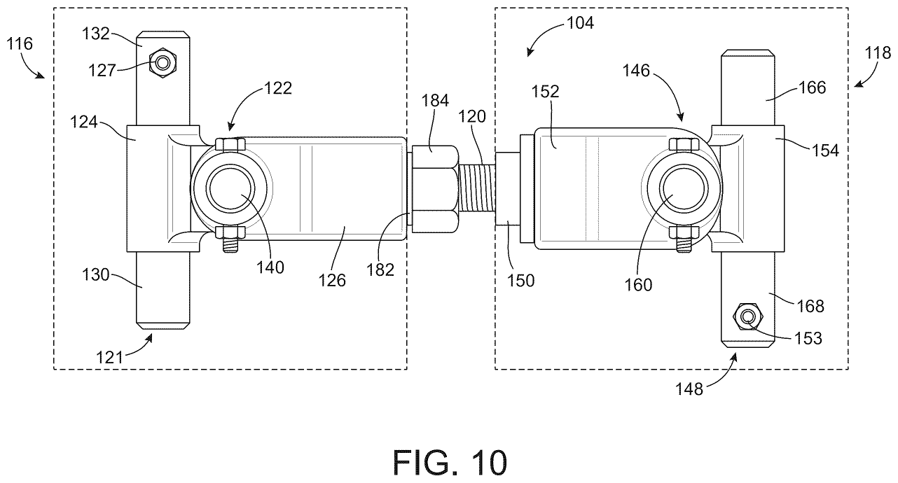

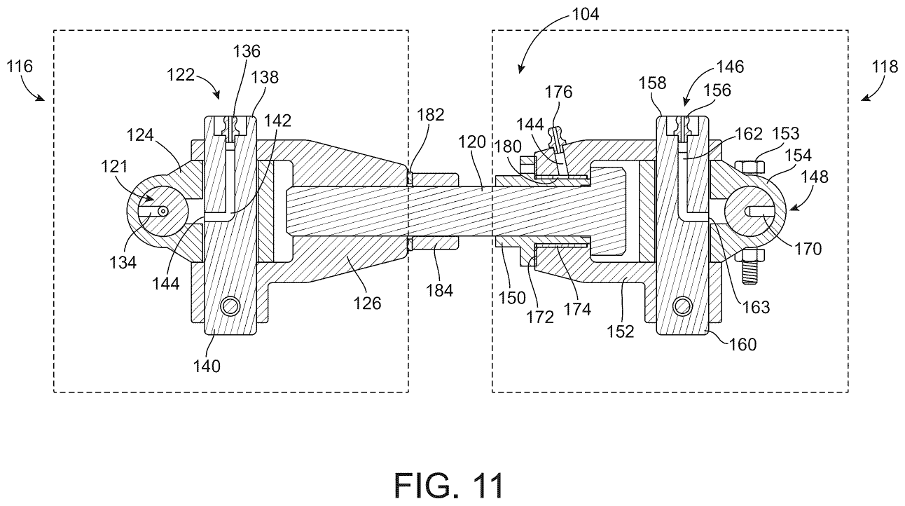

FIGS. 1-3 depict various embodiments of a cutter 100 (e.g., flex wing cutter, wing cutter, lawn mower, etc.). FIG. 2 depicts a wing 102 (e.g., adjustable portion, arm, etc.) of the cutter 100 in a first position, where the first position is when the wing 102 is parallel to a surface beneath the wing 102 (e.g., the grass being mowed, etc.) and to a central portion of the cutter 100. FIG. 3 depicts the wing 102 of the cutter 100 in a second position, in which the wing 102 is orthogonal to the surface beneath the wing 102 and to a central portion of the cutter 100. FIGS. 4-11 depict various embodiments of the adjustable link 104 (e.g., adaptable linkage, connective device, turnbuckle, etc.) of the cutter 100. The cutter 100 is configured to cut plants or materials, and the adjustable link 104 is configured to at least partially support the wing 102 through a range of motion including and between the first position and the second position (e.g., parallel to the ground, orthogonal to the ground, 45 degrees from the ground, etc.). In general, the wing 102 can be adjusted between the first and the second position by adjusting a first rotation, a second rotation, a third rotation, a fourth rotation, and a fifth rotation of the adjustable link 104, for example under mechanical, hydraulic, pneumatic, etc. forces applied by other elements of the cutter 100.

FIGS. 1-11 depict embodiments of the cutter 100 and the adjustable link 104 of the cutter. The cutter 100 includes the wing 102, a second wing 106, the adjustable link 104, a second adjustable link 108, a first connection piece 110 (e.g., support piece, connection means, etc.), a second connection piece 111 (e.g., support piece, connection means, etc.), a third connection piece 112 (e.g., support piece, connection means, etc.), a fourth connection piece 113 (e.g., support piece, connection means, etc.), a chassis 114 (e.g., framework, support, etc.), and a wheel base 115 (e.g. wing connecting portion, etc.). The wing 102 and the second wing 106 are in the first position in FIG. 1. The adjustable link 104 includes a first end portion 116 (e.g., first part, first section, etc.), a second end portion 118 (e.g., first part, first section, etc.), and a shaft 120 (e.g., bolt, rod, etc.). The shaft 120 extends between the first end portion 116 and the second end portion 118. The adjustable link 104 extends over the chassis 114 without extending over the wing 102 or the second wing 106. The chassis 114 is coupled to the first connection piece 110 and the second connection piece 111, and the first connection piece 110 and the second connection piece 111 are coupled to the first end portion 116 of the adjustable link 104. The second connection piece 111 is between the wing 102 and the first connection piece 110, and the fourth connection piece 113 is between the wing 102 and the third connection piece 112. The second end portion 118 of the adjustable link 104 is coupled to the third connection piece 112 and the fourth connection piece 113, and the third connection piece 112 and the fourth connection piece 113 are coupled to the wheel base 115. The wheel base 115 is coupled to the wing 102.

The second adjustable link 108 is coupled in a similar fashion to the chassis 114 and the second wing 106. The second adjustable link 108 extends over the chassis 114 without extend over the wing 102 or the second wing 106. In some embodiments, the second wing 106 is omitted. In some embodiments, the second adjustable link 108 is omitted. In some embodiments, the third connection piece 112 and the fourth connection piece 113 are omitted and the second end portion 118 is coupled to a portion of the wing 102. In some embodiments, the first connection piece 110 and the second connection piece 111 are omitted and the first end portion 116 is coupled to the chassis 114. In some embodiments, the adjustable link 104 or the second adjustable link 108 extends over the wing 102 or the second wing 106. In some embodiments, the adjustable link 104 terminates before extending over the chassis 114. In some embodiments, the second adjustable link 108 terminates before extending over the chassis 114.

In general, the first end portion 116 provides separate rotations about multiple rotations, referred to herein as at least a first rotation and a second rotation. The first end portion 116 includes a first pin 121 (e.g., axle, etc.), a second pin 122 (e.g., axle, etc.), first body 124 (e.g., piece, part, etc.), a second body 126 (e.g., piece, part, etc.), and a first fastener 127 (e.g., bolt, pin, etc.). The first end portion 116 provides the first rotation of the first end portion 116 about the first pin 121 (e.g., about an axis defined by the first pin 121) and the second rotation of the first end portion 116 about the second pin 122 (e.g., about an axis defined by the first pin 121). The first pin 121 is coupled to and received within a flange of the first connection piece 110 and within a flange of the second connection piece 111. The first fastener 127 couples the flange of the first connection piece 110 to the first pin 121. The first body 124 is coupled to the first pin 121, and the first body 124 is rotatable about the first pin 121 to provide the first rotation. The second pin 122 is coupled to the first body 124 and rotatable relative to the first body 124 to provide the second rotation. In the embodiment shown, the first pin 121 is orthogonal to the second pin 122 and may be offset by a different angle in various embodiments such that the first rotation and the second rotation are different degrees of freedom (e.g., rotations about different axes, rotations about offset axes, rotations about orthogonal axes, etc.).

A portion of the second body 126 straddles a portion of the first body 124 (e.g., such that the first body 124 is partially received within, between, etc. a portion of the second body 126; such that the second pin 122 extends through a first flange of the second body 126 to the first body 124 and through the first body 124 to reach a second flange of the second body 126). The second body 126 is coupled to the second pin 122 such that the second body 126 rotates with the second pin 122. The first rotation and the second rotation can be adjusted to correctly level the wing 102. In some embodiments, a portion of the second body 126 abuts a portion of the first body 124.

The first pin 121 further includes a first pin grease point 128, a first pin first end 130, a first pin second end 132, and a first pin grease channel 134 (e.g., lubrication conduit, etc.). The first pin first end 130 is on an opposite end of the first pin 121 from the first pin second end 132. The first pin first end 130 is received within the flange of the second connection piece 111 and the first pin second end 132 is received within the flange of the first connection piece 110. The first pin grease point 128 is located on the first pin first end 130 and is configured to receive grease. The first pin grease channel 134 extends through the first pin 121 from the first pin grease point 128 to the first pin second end 132 along a surface abutting the first body 124. The first pin grease channel 134 is configured to grease the surface of the first body 124 contacting the first pin 121 to help prevent corrosion and prevent metal-on-metal contact to extend the life of the first pin 121 and the first body 124. Therefore, an area where the first rotation occurs is greased, while also being protected from ingress of debris, thereby reducing friction, and improving lifespan and reliability. In some embodiments, the first pin grease channel 134 and the first pin grease point 128 are omitted. In some embodiments, there are more than one of the first pin grease channel 134 and the first pin grease point 128. In some embodiments, the first pin grease point 128 is located on the first pin second end 132. The first fastener 127 is coupled to and received within the first pin second end 132 and the flange of the first connection piece 110. In the first position, the first fastener 127 is substantially orthogonal to the chassis 114.

The second pin 122 further includes a second pin grease point 136 (e.g., lubrication receiving opening, etc.), a second pin first end 138, a second pin second end 140, a second pin grease channel 142 (e.g., lubrication conduit, etc.), and a second pin grease outlet 144 (e.g., lubrication opening, etc.). The second pin first end 138 is on an opposite end of the second pin 122 from the second pin second end 140. The second pin first end 138 is located on a side of the adjustable link 104 opposite the chassis 114. The second pin grease point 136 is located on the second pin first end 138 and is configured to receive grease. The second pin grease channel 142 extends through the second pin 122 from the second pin grease point 136 to the second pin grease outlet 144 at a surface of the second pin 122 abutting the first body 124. Therefore, an area where the second rotation occurs is greased, while also being protected from ingress of debris, thereby reducing friction, and improving lifespan and reliability. In some embodiments, the second pin grease point 136 or the second pin grease outlet 144 are omitted. In some embodiments, there are more than one of the second pin grease point 136 or the second pin grease outlet 144. In some embodiments, the second pin grease point 136 is located on the second pin second end 140.

The second end portion 118 provides the third rotation, the fourth rotation, and the fifth rotation. The second end portion 118 includes a third pin 146 (e.g., axle, etc.), a fourth pin 148 (e.g., axle, etc.), a receiving piece 150 (e.g., insertion part, etc.), a third body 152 (e.g., piece, part, etc.), a fourth body 154 (e.g., piece, part, etc.), and a second fastener 153 (e.g., bolt, pin, etc.). The second end portion 118 provides the third rotation of the second end portion 118 about the third pin 146 (e.g., about an axis defined by the third pin 146) and the fourth rotation of the second end portion 118 about the fourth pin 148 (e.g., about an axis defined by the fourth pin 148). The fourth pin 148 is coupled to and received within a flange of the third connection piece 112 and a flange of the fourth connection piece 113. The second fastener 153 couples the flange of the fourth connection piece 113 to the fourth pin 148. In the embodiment shown, the third pin 146 is orthogonal to the fourth pin 148, and may be offset at other angles in various embodiments such that the third rotation and the fourth rotation are different degrees of freedom (e.g., rotations about different axes, rotations about offset axes, rotations about orthogonal axes, etc.).

A portion of the third body 152 straddles a portion of the fourth body 154 (e.g., such that the fourth body 154 is partially received within, between, etc. a portion of the third body 152; such that the third pin 146 extends through a first flange of the third body 152 to the fourth body 154 and through the fourth body 154 to reach a second flange of the third body 152). The fourth body 154 is coupled to the third pin 146 such that the fourth body 154 rotates with the third pin 146. The fourth pin 148 is coupled to the fourth body 154 such that the fourth pin 146 provides the fourth rotation. The third connecting piece 112 and the fourth connection piece 113, the wheel base 115, and the wing 102 rotate about the fourth pin 148. The third rotation and the fourth rotation can be adjusted to correctly level the wing 102. In some embodiments, the third body 152 abuts the fourth body 154.

The third pin 146 further includes a third pin grease point 156 (e.g., lubrication receiving opening, etc.), a third pin first end 158, a third pin second end 160, a third pin grease channel 162 (e.g., lubrication conduit, etc.), and a third pin grease outlet 163 (e.g., lubrication opening, etc.). The third pin first end 158 is on an opposite end of the third pin 146 from the third pin second end 160. When the adjustable link 104 is in the first position (as in FIG. 1) the third pin first end 158 and the second pin first end 138 are on an opposite side of the adjustable link 104 from the chassis 114. The third pin grease point 156 is located on the third pin first end 158 and is configured to receive grease. The third pin grease channel 162 extends through the third pin 146 from the third pin grease point 156 to the third pin grease outlet 163 on a surface of the third pin 146 abutting the fourth body 154. The third pin grease channel 162 is configured to grease the surface of the fourth body 154 contacting the third pin 146 to help prevent corrosion and prevent metal-on-metal contact to extend the life of the third pin 146 and the fourth body 154. Therefore, an area where the third rotation occurs is greased, while also being protected from ingress of debris, thereby reducing friction, and improving lifespan and reliability. In some embodiments, the third pin grease channel 162, the third pin grease point 156, and the third pin grease outlet 163 are omitted. In some embodiments, there are more than one of the third pin grease channel 162, the third pin grease point 156, and the third pin grease outlet 163. In some embodiments, the third pin grease point 156 is located on the third pin second end 160.

The fourth pin 148 further includes a fourth pin grease point 164 (e.g., lubrication receiving opening, etc.), a fourth pin first end 166, a fourth pin second end 168, and a fourth pin grease channel 170 (e.g., lubrication conduit, etc.). The fourth pin first end 166 is opposite the fourth pin second end 168. The fourth pin first end 166 is coupled to the flange of the third connection piece 112 and the fourth pin second end 168 is coupled to the flange of the fourth connection piece 113. The second fastener 153 is coupled to and received within the fourth pin second end 168 and the flange of the fourth connection piece 113. In the first position, the second fastener 153 is substantially parallel to the chassis 114. The fourth pin grease point 164 is located on the fourth pin first end 166 and is configured to receive grease. The fourth pin grease channel 170 extends through the fourth pin 148 from the fourth pin grease point 164 to a fourth pin second end 168 along a surface abutting the fourth body 154. Therefore, an area where the fourth rotation occurs is greased, while also being protected from ingress of debris, thereby reducing friction, and improving lifespan and reliability. In some embodiments, there are more than one fourth pin grease point 164 or more than one fourth pin grease channel 170. In some embodiments, the fourth pin grease point 164 or the fourth pin grease channel 170 are omitted. In some embodiments, the fourth pin grease point 164 is located on the fourth pin second end 168.

The second end portion 118 further includes a thrust washer 172 (e.g., thrust bearing, thrust plate, etc.) and a bearing 174. The thrust washer 172 is perpendicular to the shaft 120 and is coupled between the third body 152 and the receiving piece 150. The bearing 174 is coupled between the third body 152 and the receiving piece 150. The bearing 174 is a low friction material and is parallel to the shaft 120. A surface of the bearing 174 contains holes and dimples configured to receive grease. In some embodiments, the bearing 174 is omitted. In some embodiments, the thrust washer 172 is omitted.

The second end portion 118 further includes a third body grease point 176 (e.g., lubrication receiving opening, etc.), a third body grease channel 178 (e.g., lubrication conduit, etc.), and a third body grease outlet 180 (e.g., lubrication opening, etc.). The third body grease point 176 is located on an outside of the third body 152 between the second pin 122 and the third pin 146. The third body grease point 176 is configured to receive grease. The third body grease channel 178 extends through the third body 152 from the third body grease point 176 to the third body grease outlet 180 at a surface of the third body 152 abutting the bearing 174. Therefore, an area where the fifth rotation occurs is greased, while being protected from ingress of debris thereby reducing friction while improving lifespan and reliability. In some embodiments, there are more than one third body grease outlet 180, third body grease channel 178, or third body grease point 176. In some embodiments, the third body grease outlet 180, third body grease channel 178, or third body grease point 176 are omitted. In some embodiments, when the bearing 174 is omitted, the third body grease outlet 180 is at a surface of the third body 152 abutting the receiving piece 150.

The shaft 120 extends between the first end portion 116 and the second end portion 118. The shaft 120 is selectively repositionable relative to the first end portion 116 to adjust a distance between the first end portion 116 and the second end portion 118. The second end portion 118 is configured to rotate about the shaft 120 to provide the fifth rotation without adjusting the distance between the first end portion 116 and the second end portion 118 (i.e., by rotation of the third body 152 about the receiving piece 150, without spiraling along threading which may be included on at least part of the shaft 120). As shown, the second pin 122 is substantially orthogonal to the shaft 120 and the third pin 146 is orthogonal to the shaft 120, while the first pin 121 is substantially orthogonal to the second pin 122 and the fourth pin 148 is substantially orthogonal to the third pin 146, thereby defining axes of rotation which provide angular rotation at least three degrees of freedom. In some embodiments, the first pin 121 is at a different angle relative to the second pin 122 (e.g., between zero and ninety degrees).

The receiving piece 150 is coupled (e.g., permanently coupled, for example, with Loctite, etc.) to the shaft 120, and the receiving piece 150 and the shaft 120 rotate together. The third body 152 is coupled to and receives the receiving piece 150. The third body 152 is rotatable about the receiving piece 150 to provide the fifth rotation.

The adjustable link 104 includes a washer 182 and a nut 184 coupled to the shaft 120. The washer 182 is coupled to the shaft 120 and the second body 126. The nut 184 is coupled to the shaft 120 and the washer 182. The nut 184 is configured to prevent the second body 126 from moving linearly along the shaft 120 towards or away from the third body 152. In some embodiments, the washer 182 is omitted. In other embodiments, the nut 184 is omitted. The washer 182 and the nut 184 can be adjusted (e.g., along threading of the shaft 124) to change the position of the second body 126 along the shaft 120, thereby selectively adjusting (e.g., via user articulation of the nut 184 using a wrench or the like) the distance between the first end portion 116 and the second end portion 118.

The adjustable link 104 thereby provides for angular rotation in multiple degrees of freedom (by combination of five axial rotations in the embodiments shown), while enabling translational adjustment of a distance between a first end portion 116 and the second end portion 118 (e.g., an adjustment of the overall length of the adjustable link 104, etc.). The configuration of the adjustable link 104 shown in the drawings and described in detail above thereby enables rotation of the wing 102 relative to the chassis 114, via coupling of the first connection piece 110 and the second connection piece 111 to the chassis 114, coupling of the first pin 121 to the first connection piece 110 and the second connection piece 111, coupling of the fourth pin 148 to the third connection piece 112 and the fourth connection piece 113, coupling of the third connection piece 112 and the fourth connection piece 113 to the wheelbase 115, and coupling of the wheelbase to the wing 102 while providing mechanical support which maintains a leveled configuration of the wing 102 when rotated into an in-use position. Advantageously, the rotations are provided via greased axial rotation which are protected from debris (e.g., dirt, fluid, plant matter, etc.) thereby enabling the rotations to remain low-friction and protected from degradation over equipment lifespans, which in turn prevents rotations of the adjustable link 104 from inadvertently adjusting the position of the nut 184 along the shaft (or otherwise affecting an overall length of the adjustable link 104). In view of such advantageous functions of the adjustable link 104, user re-adjustment, repair, or replacement of the adjustable link 104 in use with a flex wing cutter may thus be substantially less frequent as compared to usage of prior turnbuckle designs.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the cutter 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An adjustable link for a flex wing cutter, comprising:
a first end portion providing first rotation about a first pin of the first end portion and second rotation about a second pin of the first end portion;
a second end portion providing third rotation about a third pin of the second end portion and fourth rotation about a fourth pin of the second end portion;
a shaft extending between the first end portion and the second end portion and selectively repositionable relative to the first end portion to adjust a distance between the first end portion and the second end portion;
wherein the second end portion is configured to rotate about the shaft to provide a fifth rotation without adjusting the distance between the first end portion and the second end portion.

2. The adjustable link of claim 1, wherein:
the first end portion comprises:
the first pin;
a first body coupled to the first pin, the first body rotatable about the first pin to provide the first rotation;
the second pin coupled to the first body and rotatable relative to the first body to provide the second rotation; and
a second body coupled to the second pin such that the second body rotates with the second pin; and
the second end portion comprises:
a receiving piece coupled to the shaft;
a third body coupled to the receiving piece and rotatable about the receiving piece to provide the fifth rotation;
the third pin coupled to the third body;
a fourth body coupled to the third pin and rotatable about the third pin to provide the third rotation, the third body configured to rotate with the third pin relative to the fourth body; and
the fourth pin coupled to the fourth body, wherein the fourth pin is rotatable about the fourth body to provide the fourth rotation.

3. The adjustable link of claim 2, wherein a portion of the second body straddles a portion of the first body.

4. The adjustable link of claim 2, wherein a portion of the third body straddles a portion of the fourth body.

5. The adjustable link of claim 2, further comprising:
a second pin grease point on a second pin first end, the second pin grease point configured to receive grease; and
a third pin grease point on a third pin first end, the third pin grease point configured to receive grease.

6. The adjustable link of claim 5, further comprising:
a second pin grease channel extending through the second pin from the second pin grease point to a second pin grease outlet at a surface of the second pin abutting the first body; and
a third pin grease channel extending through the third pin from the third pin grease point to a third pin grease outlet at a surface of the third pin abutting the fourth body.

7. The adjustable link of claim 2, further comprising:
a bearing coupled between the third body and the receiving piece;
a third body grease point on an outside of the third body, the third body grease point configured to receive grease; and
a third body grease channel extending through the third body from the third body grease point to a third body grease outlet at a surface of the third body abutting the bearing.

8. The adjustable link of claim 7, further comprising:
a first pin grease point on a first pin first end, the first pin grease point configured to receive grease; and
a first pin grease channel extending through the first pin from the first pin grease point to a first pin second end along a surface abutting the first body.

9. The adjustable link of claim 2, further comprising:
a fourth pin grease point on a fourth pin first end, the fourth pin grease point configured to receive grease; and
a fourth pin grease channel extending through the fourth pin from the fourth pin grease point to a fourth pin second end along a surface abutting the fourth body.

10. The adjustable link of claim 2, further comprising:
a bearing coupled between the third body and the receiving piece, the bearing parallel to the shaft.

11. The adjustable link of claim 10, wherein the bearing is a low friction material, the bearing including holes and dimples configured to receive grease.

12. The adjustable link of claim 2, wherein the receiving piece and the shaft are permanently coupled and rotate together.

13. The adjustable link of claim 2, further comprising:
a thrust washer coupled between the third body and the receiving piece, the thrust washer perpendicular to the shaft.

14. The adjustable link of claim 2, further comprising:
a washer coupled to the second body and the shaft;
a nut coupled to the shaft and the washer;
wherein the nut is configured to prevent the second body from moving linearly along the shaft towards or away from the third body.

15. The adjustable link of claim 2, wherein the first pin is orthogonal to the second pin and the second pin is orthogonal to the shaft.

16. The adjustable link of claim 2, wherein the third pin is orthogonal to the fourth pin and the third pin is orthogonal to the shaft.

17. A cutter comprising:
an adjustable link comprising:
a first end portion providing first rotation about a first pin of the first end portion and second rotation about a second pin of the first end portion,
a second end portion providing third rotation about a third pin of the second end portion and fourth rotation about a fourth pin of the second end portion, and
a shaft extending between the first end portion and the second end portion and selectively repositionable relative to the first end portion to adjust a distance between the first end portion and the second end portion; and
a wing utilizing the first rotation, the second rotation, the third rotation, the fourth rotation, and the fifth rotation;
wherein the second end portion is configured to rotate about the shaft to provide the fifth rotation without adjusting the distance between the first end portion and the second end portion.

18. A cutter comprising:
a chassis;
a first connection piece coupled to the chassis;
an adjustable link comprising:
a first end portion providing first rotation about a first pin of the first end portion and second rotation about a second pin of the first end portion, the first end portion coupled to the first connection piece,
a second end portion providing third rotation about a third pin of the second end portion and fourth rotation about a fourth pin of the second end portion, and
a shaft extending between the first end portion and the second end portion and selectively repositionable relative to the first end portion to adjust a distance between the first end portion and the second end portion;
a second connection piece coupled to the second end portion;
a wing coupled to the second connection piece;
wherein the second end portion is configured to rotate about the shaft to provide a fifth rotation without adjusting the distance between the first end portion and the second end portion.

19. The cutter of claim 18, wherein the adjustable link extends over the chassis and does not extend over the wing.

20. The cutter of claim 18, wherein the adjustable link is a first adjustable link and the wing is a first wing, further comprising:
a second wing; and
a second adjustable link,
wherein the first adjustable link and the second adjustable link extend over the chassis.
